(19) United States
(12) Patent Application Publication
(10) Pub. No.: US 2005/0212694 A1
(43) Pub. Date: Sep. 29, 2005

(54) Data distribution method and system

(76) Inventors: Chun-Ta Chen, Sanxia Township (TW); Youn-Tih Fung, Taipei City (TW); Yeong-Shiou Hsiao, Taipei City (TW); Yuh-Ming Liu, Wugu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/811,083

(22) Filed: Mar. 26, 2004

(51) Int. Cl. G01S 13/00

(52) U.S. Cl. 342/59; 342/189; 342/195

(57) ABSTRACT

A computer implemented data distribution method for radar data. The method first receives distribution groups. Each distribution group corresponds to a data storage terminal and includes source code corresponding to data collection terminals. Next, the method calculates distances between the data storage terminals and the data collection terminals and selects the source code in the distribution groups with a shortest distance. In the previous comparison, if the priority levels of the source code are the same, distances between the data storage terminals and the data collection terminal corresponding to the repeated source code are calculated. The source code is selected for a distribution group which has the shortest distance. The steps are repeated until the source code is all selected.

### BACKGROUND OF THE INVENTION

1. Field of the Invention

The present invention relates to data distribution technology and in particular to a distribution method and system for radar data.

2. Description of the Related Art

The progress of collection technology for radar data allows application in various systems, such as climate analysis, navigation control, and geography detection. Radar data is normally distributed in a Mosaic distribution rule and stored in dedicated radar data control terminals for further use or processing.

FIG. 1 is a diagram of radar terminals and radar data control terminals. Five radar terminals for data collection are established in an area, i.e. radar terminals A, B, C, D, and E. The data collection ranges of the radar terminals are illustrated as circles in FIG. 1. Four radar data control terminals for data storage are also established in the area, i.e. radar data control terminals 1, 2, 3, and 4, as shown by triangles. Data storage range of the radar data control terminals is basically distributed by dotted lines. The topography of the exemplary area presents an island with mountains in the center.

FIG. 2 is a diagram of radar sort boxes produced by a Mosaic distribution rule, according to the geographic characteristics of a given area, such as plains, hills, mountains, or sea. The Mosaic distribution rule divides the area into radar sort boxes according to the geographic characteristics, as depicted in FIG. 2 as radar sort boxes a to v. The radar sort boxes can be divided with equal superficial measurements or not, depending on actual requirements.

FIG. 3 is a diagram of the radar data, distributed by a Mosaic distribution rule, to the radar data control terminals according to the relationships between the radar sort boxes, the radar terminals, and the radar data control terminals. The left side of FIG. 3 shows the radar terminals, the right side the radar data control terminals, and the center the radar sort boxes. The distribution result is shown in the right side of FIG. 3. For example, radar data terminal 1 stores and displays radar data collected by radar terminals A, B, C, and D. Radar data terminal 2 stores and displays radar data collected by radar terminals B, C, and A. The radar data control terminals 3 and 4 correspond to the radar terminals 1 and 2.

As mentioned, the radar data is stored repeatedly in different radar data control terminals using the conventional radar data distribution rule. Generally, the radar data is voluminous, and the repeated data storage creates wasted storage space and human resource. A more efficient and systematic method of distributing radar data to radar data control terminals is thus necessary.

### SUMMARY

Accordingly, an object of the invention is to provide a systematic method to distribute radar data to radar data control terminals based on a Mosaic distribution rule.

To achieve the foregoing and other objects, the invention discloses a computer implemented data distribution method for radar data. First, distribution groups, corresponding to data storage terminals, are received. Each distribution group comprises source code corresponding to data collection terminals. The source code is attached with priority levels to represent processing order in the distribution group. Next, distances between each data storage terminal and composed data collection terminals are calculated. The source code with the shortest distance for each distribution group is selected. If a source code is selected repeatedly in the distribution groups, the priority levels of the source code in the repeated distribution groups are compared. The source code is selected in the distribution group in which the source code has a highest priority level. If the priority levels of the source code are the same, distances between the data storage terminals and the data collection terminal corresponding to the repeated source code are calculated. The source code is selected in a distribution group with the shortest distance. The calculation, selection, and comparison operations described are executed until all source code is selected.

### BRIEF DESCRIPTION OF THE DRAWINGS

The present invention can be more fully understood by reading the following detailed description and examples with references made to the accompanying drawings, wherein:

FIG. 1 is a diagram of radar terminals and radar data control terminals.

FIG. 2 is a diagram of the radar sort boxes produced by a Mosaic rule.

FIG. 3 is a diagram of the radar data distributed by a Mosaic distribution rule.

FIG. 4 is a flowchart of radar data distribution according to one embodiment of the present invention.

FIG. 5a to FIG. 5e are diagrams of radar data distribution according to one embodiment of the present invention.

FIG. 6 is a diagram of the machine-readable storage medium for storing a computer program providing a radar data distribution method.

FIG. 7 is a diagram of the radar data distribution system according to one embodiment of the present invention.

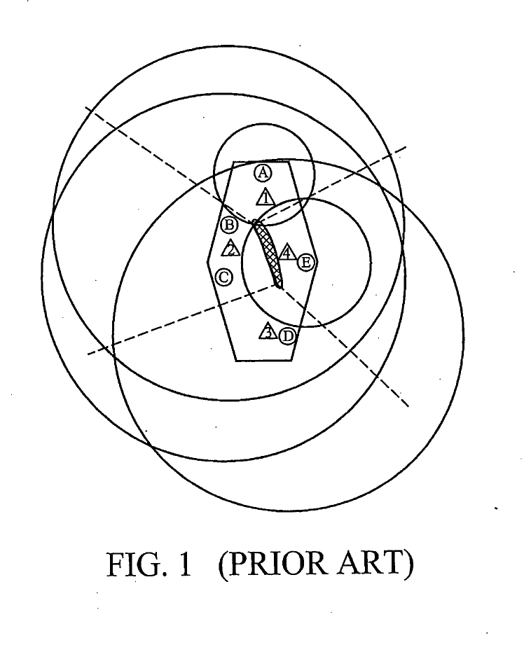

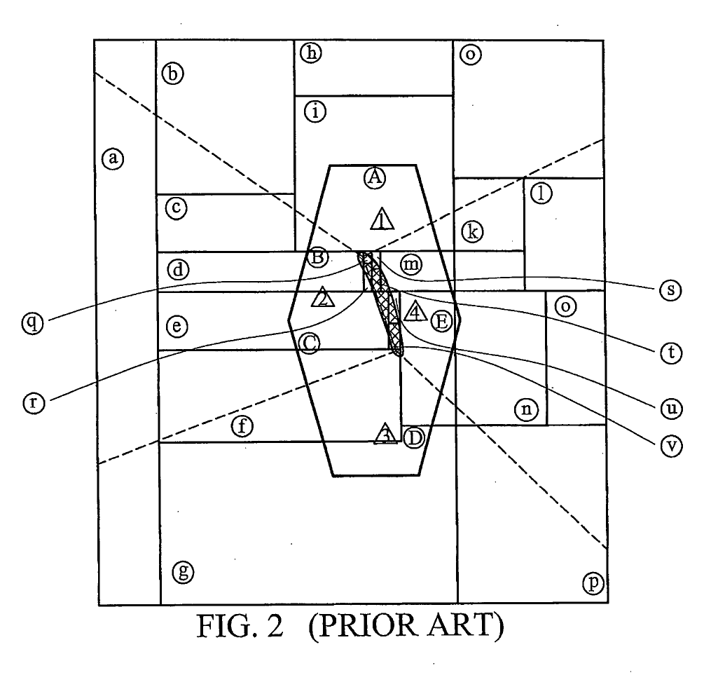

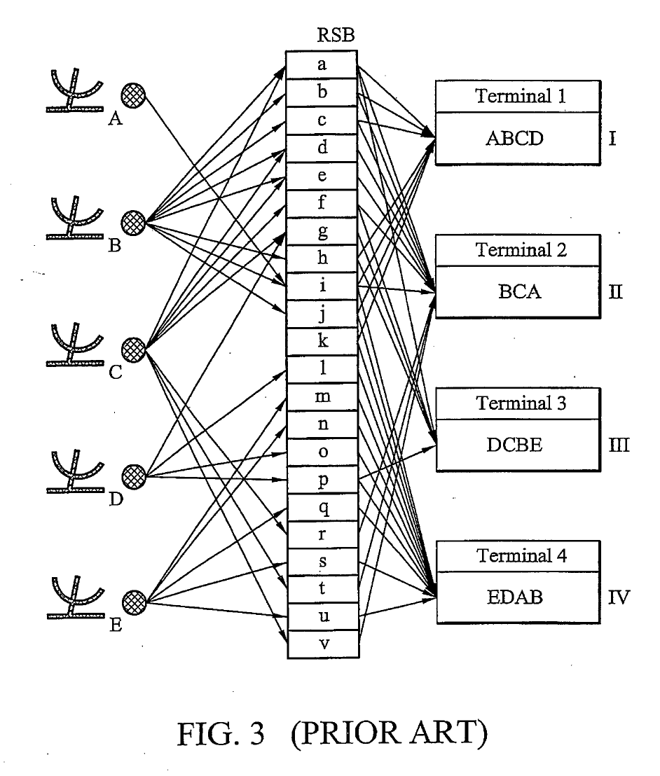

### DETAILED DESCRIPTION OF THE INVENTION

As summarized above, the present invention discloses a computer implemented data distribution method for radar data. First, distribution groups corresponding to data storage terminals are received. Each distribution group comprises source code. Each source code corresponds to a data collection terminal and has a priority level for representing processing order therein.

The data collection terminals are radar terminals for collecting radar data. The data storage terminals are radar data control terminals for storing radar data. The distribution groups are the result of a Mosaic distribution rule for distributing radar data to data storage terminals.

Next, distances between each data storage terminal and composed data collection terminals are calculated. Source code with the shortest distance is selected in each distribution group.

Further, if a source code is selected repeatedly in the distribution groups, the priority levels of the source code are compared in repeated distribution groups. The source code is selected for a distribution group in which the source code has a highest priority level.

If the priority levels of the source code are the same, distances between the data storage terminals and the data collection terminal corresponding to the repeated source code are calculated. The source code is selected for a distribution group having the shortest distance. Here, the calculation of the distances is geographic.

The mentioned steps, such as calculation, selection, and comparison, are repeated until all source code is selected. Afterwards, the distribution groups and the source code are combined into second distribution groups. The radar data can be distributed to the data storage terminals according to the second distribution groups.

Thus, a data distribution method is provided, especially for radar data distribution. The provided method receives distribution groups, produced by a Mosaic distribution rule or other data distribution rules, and redistributes the distribution groups to reduce data storage redundancy.

Moreover, a machine-readable storage medium for storing a computer program providing a data distribution method for radar data is disclosed. The method comprises the mentioned steps.

Furthermore, a data distribution system is disclosed. The system includes a receiving module, a first distribution module, a second distribution module, a third distribution module, and a fourth distribution module.

The receiving module receives distribution groups. Each distribution group corresponds to a data storage terminal, such as a radar data control terminal. Each distribution group comprises source code, corresponding to data collection terminals, such as radar terminals. A priority level is attached to the source code in each distribution group to represent processing order of the source code therein. The distribution groups are the result produced by a Mosaic distribution rule.

The first distribution module calculates distances between each data storage terminal and the composed data collection terminals and selects the source code with the shortest distance in each distribution group.

If source code is selected repeatedly in the distribution groups, the second distribution module compares the priority levels of the source code for the repeated distribution groups. The source code is selected for the distribution group in which the source code has a highest priority level.

In the comparison of the second distribution module, if the priority levels of the source code are the same, the third distribution module calculates distances between the data storage terminals and the data collection terminal corresponding to the repeated source code. The source code is selected for the distribution group having the shortest distance.

Here, the distance calculation of the first and the third distribution module is geographic. If there source code remaining unselected, the fourth distribution module executes the second and the third distribution modules according to the unselected source code and the distribution groups until all source code is selected.

The disclosed system further comprises a combination module and a storage module. The combination module combines the distribution groups and the source code into second distribution groups. The storage module stores the radar data to the data storage terminals according to the second distribution groups.

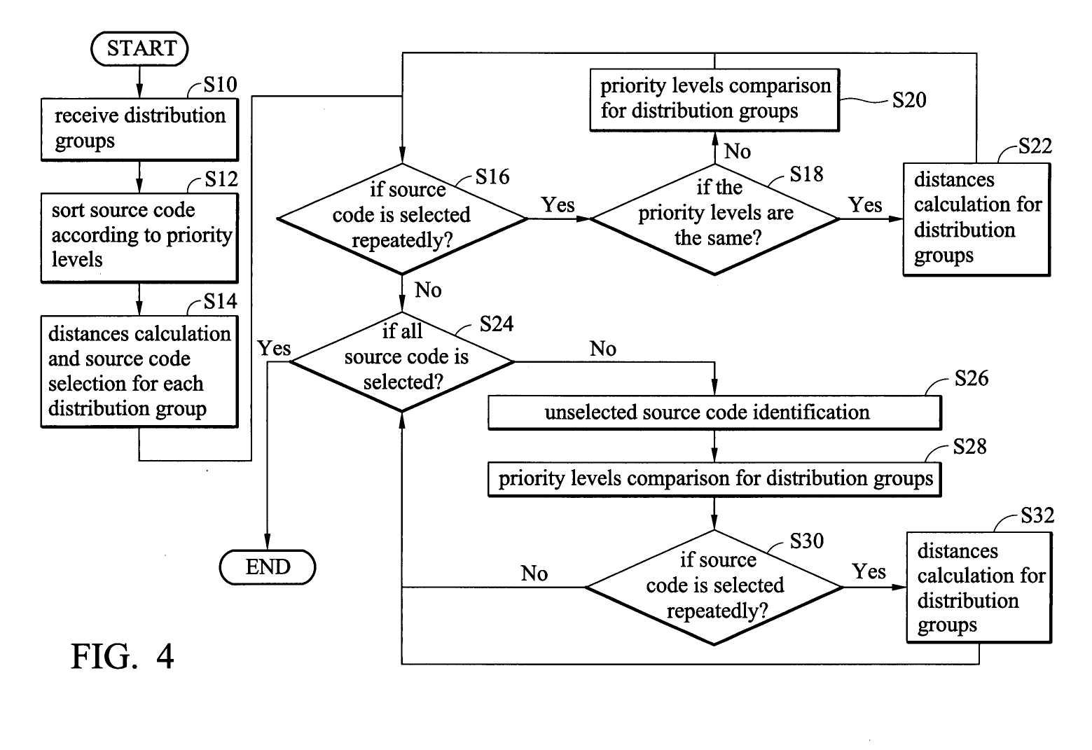

FIG. 4 is a flowchart of radar data distribution according to one embodiment of the present invention. In the embodiment, distribution groups corresponding to data storage terminals are first received (step S10). Each distribution group comprises source code. Each source code corresponds to a data collection terminal and has a priority level for representing processing order therein. The source code can be sorted according to the priority levels in each distribution groups (step S12).

The data collection terminals are radar terminals for collecting radar data. The data storage terminals are radar data control terminals for storing the radar data. The distribution groups are the result of a Mosaic distribution rule, distributing radar data to radar data control terminals.

Next, distances between each data storage terminal and the composed data collection terminals are calculated. Source code with the shortest distance is selected for each distribution group (step S14).

Carrying on, if source code is selected repeatedly in the distribution groups (step S16), the priority levels of the source code are compared in the repeated distribution groups (step S18). The source code is selected for a distribution group in which the source code has a highest priority level (step S20).

If the priority levels of the source code are the same, distances between the data storage terminals and the data collection terminal corresponding to the repeated source code are calculated (step S22). The source code is selected for a distribution group which has the shortest distance. Here, the distance calculation is geographic.

It is determined if all source code is selected (step S24). Unselected source code is then identified (step S26) and the mentioned steps S20, S16, and S22 (step S28, S30, S32) are repeated until all source code is selected.

Thereafter, the distribution groups and the source code are combined into second distribution groups. The radar data can be distributed to the data storage terminals according to the second distribution groups.

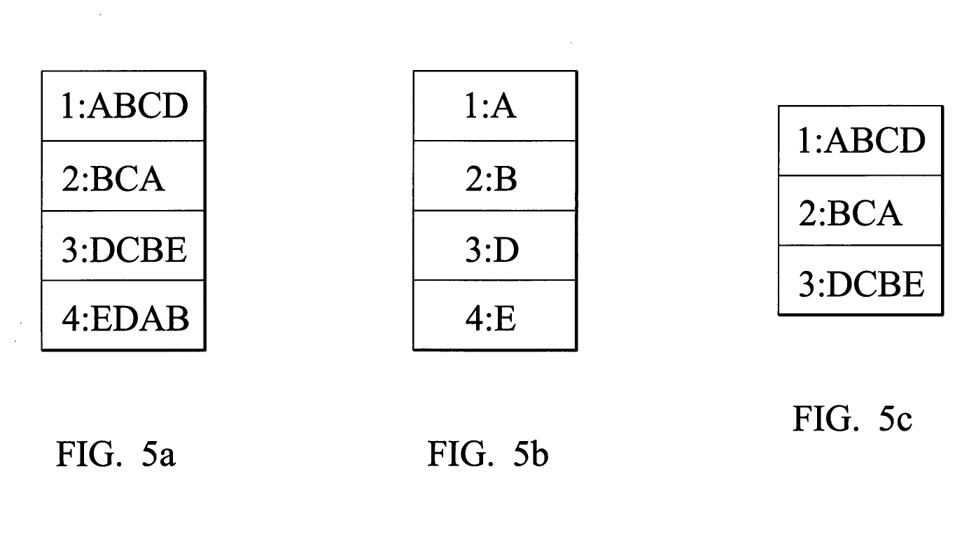

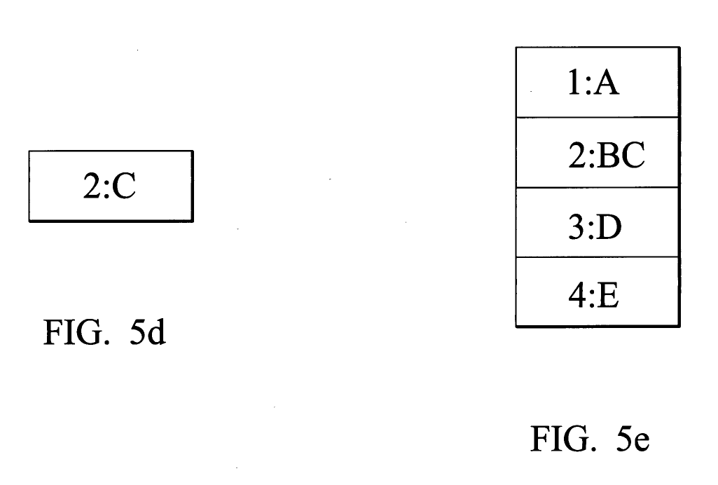

FIG. 5a to FIG. 5e are diagrams of radar data distribution according to one embodiment of the present invention. In the embodiment, distribution groups corresponding to data storage terminals are first received.

Distribution group 1 corresponds to radar data control terminal 1 and comprises source code A, B, C, and D, which correspond to radar terminals A, B, C, and D in turn. The priority levels of the source code are A over B, B over C, and C over D. Distribution group 2 corresponds to radar data control terminal 2 and comprises source code B, C, and A. The priority levels of the sources code are B over C and C over A. Distribution groups 3 and 4 are similar to groups 1 and 2.

The geographic distances between each radar data control terminal and the composed radar terminals are measured. Source code with the shortest distance is selected in each distribution group, as shown in FIG. 5b. In distribution group 1, the shortest distance between radar data control terminal 1 and radar terminal A, B, C, and D is radar terminal A, thus, source code A is selected for distribution group 1. In distribution group 2, the shortest distance is radar terminal B, thus, source code B is selected for distribution group 2. Groups 3 and 4 are executed similarly.

Further, it is determined whether source code is selected repeatedly for the distribution groups. In the embodiment, none is.

It is then determined if the source code is all selected. Here, source code C has not been selected, and appears in distribution group 1, 2, and 3, as shown in FIG. 5c. The priority levels of the source code C in the distribution groups 1, 2, and 3 are compared to select the highest. Source code C has a third priority level in distribution group 1, a second priority level in distribution group 2, and a second priority level in the distribution 3. Thus, source code C is selected in distribution groups 2 and 3.

Source code C appears in the distribution groups 2 and 3 repeatedly. The distances between the radar data control terminal 1 and the radar terminal C, and the distance between the radar data control terminal 2 and the radar terminal C are measured. The shortest is the distance between the radar data control terminal 2 and the radar terminal C. Thus, source code C is selected for the distribution group 2, as shown in FIG. 5d.

Finally, it is determined if the source code has all been selected. If not, the previous steps are repeated.

Afterwards, the distribution groups and the selected source code are combined into second distribution groups, as shown in FIG. 5e. The radar data can be distributed to the radar data control terminals according to the second distribution groups, reducing data storage redundancy.

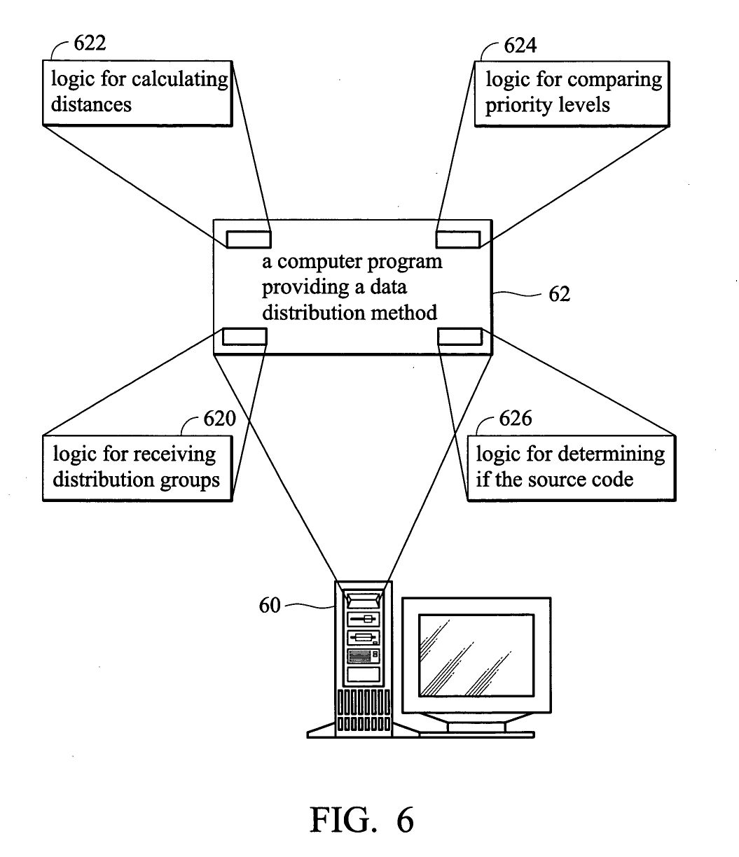

FIG. 6 is a diagram of the machine-readable storage medium for storing a computer program providing a radar data distribution method. A machine-readable storage medium 60 for storing a computer program 62 providing a data distribution method is disclosed. The computer program 62 mainly comprises logic for receiving distribution groups 620, logic for calculating distances 622, logic for comparing priority levels 624, and logic for determining if the source code is selected 626.

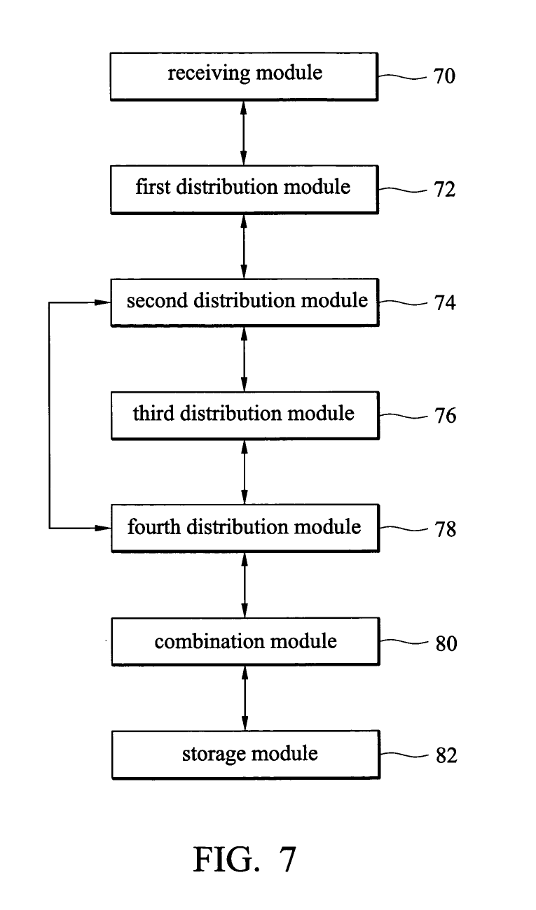

FIG. 7 is a diagram of the radar data distribution system according to one embodiment of the present invention. In one embodiment, the system includes a receiving module 70, a first distribution module 72, a second distribution module 74, a third distribution module 76, a fourth distribution module 78, a combination module 80, and a storage module 82.

The receiving module 70 receives distribution groups. Each distribution group corresponds to a data storage terminal, such as a radar data control terminal. Each distribution group comprises source code, corresponding to data collection terminals, such as radar terminals. Each source code has a priority level in each distribution group to represent processing order therein. The distribution groups are the result produced by a Mosaic distribution rule.

The first distribution module 72 calculates distances between each data storage terminal and composed data collection terminals and selects the source code with the shortest distance.

If source code is selected repeatedly in the distribution groups, the second distribution module 74 compares the priority levels of the source code for the repeated distribution groups. The source code is selected in the distribution group in which the source code has the highest priority level. The distance calculation is geographic.

In the comparison of the second distribution module 74, if the priority levels of the source code are the same, the third distribution module calculates distances between the data storage terminals and the data collection terminal corresponding to the repeated source code. The source code is selected in the distribution group having the shortest distance.

The fourth distribution module 78 executes the second and the third distribution modules 74, 76 according to the unselected source code and the distribution groups.

The combination module 80 combines the distribution groups and the selected source code into second distribution groups according to the selection. The storage module 82 stores the radar data to the data storage terminals according to the second distribution groups.

Thus, a data distribution method based on a Mosaic distribution rule is disclosed. The disclosed method can redistribute the distribution results and store data according thereto, reducing storage space for radar data.

It will be appreciated from the foregoing description that the method and system described herein provide a dynamic and robust solution to the data storage problem. If, for example, the distribution rules, the data collection terminals, or the data storage terminals are altered, the method and system of the present invention can be adjusted accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over a transmission medium, such as electrical wire, cable, fiberoptics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer implemented data distribution method for radar data, comprising the steps of:
(a) receiving at least one distribution group, wherein each distribution group corresponds to a data storage terminal and comprises at least one source code, wherein each source code corresponds to a data collection terminal and has a priority level for representing a processing order therein;
(b) calculating distances between the data storage terminal and the composed data collection terminal and selecting the source code with the shortest distance for each distribution group;
(c) if source code is selected repeatedly in the distribution groups, comparing the priority levels of the source code in the repeated distribution groups and selecting the source code for a distribution group in which the source code has a highest priority level;
(d) if the priority levels of the source code are the same, calculating distances between the data storage terminals and the data collection terminal corresponding to the repeated source code, and selecting the source code for the distribution group which has the shortest distance; and
(e) executing step (c) and step (d) until the source code is all selected.

2. The computer implemented data distribution method as claimed in claim 1, wherein the data collection terminals are radar terminals for collecting radar data and the data storage terminals are radar data control terminals for storing the radar data.

3. The computer implemented data distribution method as claimed in claim 2, wherein the distribution groups are produced by distributing the radar data to the data storage terminals according to a Mosaic distribution rule.

4. The computer implemented data distribution method as claimed in claim 2, further comprising the steps of:
combining the distribution groups and the selected source code into at least one second distribution group; and
storing the radar data to the data storage terminals according to the second distribution group.

5. The computer implemented data distribution method as claimed in claim 1, wherein, distance calculation in step (b) and step (c) is geographic.

6. A machine-readable storage medium storing a computer program providing a computer implemented data distribution method for radar data, the method comprising the steps of:
(a) receiving at least one distribution group, wherein each distribution group corresponds to a data storage terminal and comprises at least one source code, wherein each source code corresponds to a data collection terminal and has a priority level for representing a processing order therein;
(b) calculating distances between the data storage terminal and the composed data collection terminal and selecting the source code with the shortest distance for each distribution group;
(c) if the source code is selected repeatedly in the distribution groups, comparing the priority levels of the source code for the repeated distribution groups and selecting the source code in a distribution group in which the source code has a highest priority level;
(d) in comparison of the step (c), if the priority levels of the source code are the same, calculating distances between the data storage terminals and the data collection terminal corresponding to the repeated source code, and selecting the source code in the distribution group which has the shortest distance; and
(e) executing step (c) and step (d) until the source code is all selected.

7. The machine-readable storage medium as claimed in claim 6, wherein the data collection terminals are radar terminals for collecting radar data and the data storage terminals are radar data control terminals for storing the radar data.

8. The machine-readable storage medium as claimed in claim 7, wherein the distribution groups are produced by distributing the radar data to the data storage terminals according to a Mosaic distribution rule.

9. The machine-readable storage medium as claimed in claim 7, further comprising the steps of:
combining the distribution groups and the selected source code into at least one second distribution group; and
storing the radar data to the data storage terminals according to the second distribution group.

10. The machine-readable storage medium as claimed in claim 6, wherein, distance calculation in step (b) and step (c) is geographic.

11. A system for radar data distribution, comprising:
a receiving module, receiving at least one distribution group, wherein each distribution group corresponds to a data storage terminal and comprises at least one source code, wherein each source code corresponds to a data collection terminal and has a priority level for representing a processing order therein;
a first distribution module, coupled to the receiving module, calculating distances between the data storage terminal and the composed data collection terminal and selecting the source code with the shortest distance for each distribution group;
a second distribution module, coupled to the first distribution module, if the source code is selected repeatedly for the distribution groups, comparing the priority levels of the source code for the repeated distribution groups and selecting the source code in a distribution group in which the source code has the highest priority level;
a third distribution module, coupled to the second distribution module, if the priority levels of the source code are the same, calculating distances between the data storage terminals and the data collection terminal corresponding to the repeated source code, and selecting the source code for the distribution group which has the shortest distance; and
a fourth distribution module, coupled to the second and the third distribution module, executing the second and the third distribution module until the source code is all selected.

12. The system as claimed in claim 11, wherein the data collection terminals are radar terminals for collecting radar data and the data storage terminals are radar data control terminals for storing the radar data.

13. The system as claimed in claim 12, wherein the distribution groups are produced by distributing the radar data to the data storage terminals according to a Mosaic distribution rule.

14. The system as claimed in claim 12, further comprising:
a combination module, combining the distribution groups and the selected source code into at least one second distribution group; and
a storage module, coupled to the combination module, storing the radar data to the data storage terminals according to the second distribution group.

15. The system as claimed in claim 11, wherein distance calculation in the first and the second distribution module is geographic.
